(19) United States
(12) Patent Application Publication
(10) Pub. No.: US 2014/0098746 A1
(43) Pub. Date: Apr. 10, 2014

(54) COMMUNICATION METHOD, BASE STATION, AND TERMINAL DEVICE

(71) Applicant: HUAWEI TECHNOLOGIES CO., LTD., Shenzhen (CN)

(72) Inventors: Haiyan LUO, Shanghai (CN); Tianle Deng, Shanghai (CN); Binsong Tang, Shanghai (CN); Li Yang, Shanghai (CN)

(73) Assignee: HUAWEI TECHNOLOGIES CO., LTD., Shenzhen (CN)

(21) Appl. No.: 14/105,801

(22) Filed: Dec. 13, 2013

Related U.S. Application Data
(63) Continuation of application No. PCT/CN2012/077062, filed on Jun. 18, 2012.

(30) Foreign Application Priority Data
Jun. 17, 2011 (CN) 201110163877.9

(51) Int. Cl. H04L 5/00; H04W 52/24

(52) U.S. Cl. CPC H04L 5/0032; H04W 52/244
USPC 370/328

(57) ABSTRACT

The present invention provides a communication method. The method includes: determining, by a first base station serving a first cell, a position of an almost blank subframe and transmission power of the almost blank subframe according to obtained adjustment information about a second cell of a second base station; and determining a frame structure for the second cell according to the adjustment information, the position of the almost blank subframe, and the transmission power of the almost blank subframe. The present invention further provides a base station and a terminal device. With the present invention, transmission power of each almost blank subframe may be adaptively adjusted according to the adjustment information about the second cell, so that interference between the first cell and the second cell is reduced.

### CROSS-REFERENCE TO RELATED APPLICATIONS

This application is a continuation of International Application No. PCT/CN2012/077062, filed on Jun. 18, 2012, which claims priority to Chinese Patent Application No. 201110163877.9, filed on Jun. 17, 2011, all of which are hereby incorporated by reference in their entireties.

### TECHNICAL FIELD

The present invention relate to the field of communication technologies, and in particular, to a communication method, a base station, and a terminal device.

### BACKGROUND

With the development of the Third Generation Partnership Project (Third Generation Partnership Project, 3GPP for short below), higher peak user throughput, average user throughput, and edge user throughput may be provided to bring better data transmission experience to users. Meanwhile, problems of interference between cells that provide communication services for users and are within the coverage of a base station arise. How to effectively solve inter-cell interference and improve system resource utilization becomes a critical problem to be solved in the industry.

### SUMMARY

The present invention provides a communication method, a base station, and a terminal device to solve the problem of interference between different cells.

In one aspect, the present invention provides a communication method, including:

determining, by a first base station serving a first cell, a position of an almost blank subframe and transmission power of the almost blank subframe according to obtained adjustment information about a second cell of a second base station; and

determining a frame structure for the second cell according to the adjustment information, the position of the almost blank subframe, and the transmission power of the almost blank subframe.

In another aspect, the present invention provides a base station, including:

a first receiver, configured to receive adjustment information about a second cell of a second base station;

a first processor, configured to determine a position of an almost blank subframe and transmission power of the almost blank subframe according to the adjustment information, and determine a frame structure for the second cell according to the adjustment information, the position of the almost blank subframe, and the transmission power of the almost blank subframe; and

a first transmitter, configured to send the frame structure to the second base station.

In still another aspect, the present invention provides a base station, including:

a second transmitter, configured to transmit adjustment information about a second cell of the base station to a first base station serving a first cell;

a second receiver, configured to receive a position of an almost blank subframe and transmission power of the almost blank subframe, which are determined by the first base station according to the adjustment information; and

a second processor, configured to determine a frame structure for the second cell according to the adjustment information, the position of the almost blank subframe, and the transmission power of the almost blank subframe.

In still another aspect, the present invention provides a terminal device, including:

a third receiver, configured to receive a frame structure for a second cell of a second base station, which is sent in a first cell by a first base station, where the frame structure is determined by the first base station according to adjustment information about the second cell, a subframe position of an almost blank subframe, and transmission power of the almost blank subframe; and

a third transmitter, configured to send the frame structure to the second base station.

In still another aspect, the present invention provides a terminal device, including:

a fourth receiver, configured to receive a subframe position of an almost blank subframe and transmission power of the almost blank subframe, which are sent in a first cell by a first base station and determined according to adjustment information about a second cell of a second base station; and

a fourth transmitter, configured to send the subframe position of the almost blank subframe and the transmission power of the almost blank subframe to the second base station, so that the second base station determines a frame structure for the second cell according to the adjustment information about the second cell, the subframe position of the almost blank subframe, and the transmission power of the almost blank subframe.

With the present invention, transmission power of each almost blank subframe may be adaptively adjusted according to the adjustment information about the second cell, so that interference between the first cell and the second cell is reduced, and the spectrum efficiency of the first cell on the almost blank subframe is improved. Different time domain transmission resources may also be flexibly allocated according to different service requirements of the second cell.

### BRIEF DESCRIPTION OF DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a schematic flowchart of a communication method according to a first embodiment of the present invention;

FIG. 2 is a schematic flowchart of a communication method according to a second embodiment of the present invention;

FIG. 3 is a schematic flowchart of a communication method according to a third embodiment of the present invention;

FIG. 4 is a schematic flowchart of a communication method according to a fourth embodiment of the present invention;

FIG. 5 is a schematic diagram of a network according to the present invention;

FIG. 6 is a schematic diagram of a base station according to a fifth embodiment of the present invention;

FIG. 7 is a schematic diagram of a base station according to a sixth embodiment of the present invention;

FIG. 8 is a schematic diagram of a terminal device according to a seventh embodiment of the present invention; and

FIG. 9 is a schematic diagram of a terminal device according to an eighth embodiment of the present invention.

### DESCRIPTION OF EMBODIMENTS

To make the objectives, technical solutions, and advantages of the embodiments of the present invention more comprehensible, the following clearlyy describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

Persons skilled in the art may understand that the accompanying drawings are only schematic diagrams of exemplary embodiments of the present invention and that the modules or procedures in the accompanying drawings may be probably not necessary for the implementation of the present invention.

Persons skilled in the art may understand that the modules of the apparatuses in the embodiments may be disposed in the apparatuses as described in the embodiments or disposed in one or more apparatuses other than the apparatuses in the embodiments. In addition, the modules of the embodiments may be combined into one module, or further split into multiple submodules.

Persons skilled in the art may understand that all or part of the steps in the methods of the embodiments may be implemented by a program instructing relevant hardware. The program may be stored in a computer readable storage medium and when the program is executed, the procedures in the methods of the embodiments are performed. The storage medium may be any medium that can store program code, such as a ROM, a RAM, a magnetic disk, or an optical disc.

A communication system applied to different embodiments of the present invention includes at least one first base station and at least one second base station. The first base station serves one or more first cells, and the second base station serves one or more second cells. The first cell is an interference source cell, and the second cell may be a victim cell, where the interference source cell and victim cell are relative concepts, the interference source cell may be regarded as a cell causing signal interference to the communication of the victim cell, and the victim cell may be regarded as a cell receiving interference from the interference source cell during communication. Persons skilled in the art may understand that the first base station may be referred to as the base station serving the interference source cell and that the second base station may be referred to as the base station of the victim cell. The multiple second cells (namely, victim cells) may be served by one second base station or may also be served by different second base stations. For example, the interference source cell and the victim cell are neighboring cells. For another example, the base station serving the victim cell and the interference source cell may be a macro base station, or a macro-micro base station, or a micro base station, and so on, which is not limited by embodiments of the present invention.

Different embodiments of the present invention introduce a time-domain inter-cell interference coordination mechanism, in which the interference source cell sends a subframe format having an almost blank subframe (Almost Blank Subframe, ABS for short) to the victim cell to solve the problem of channel interference during mixed deployment of the interference source cell and the victim cell. The almost blank subframe refers to a subframe that has low power or is less active on radio resources. For example, the almost blank subframe does not carry data and control signaling. For another example, the almost blank subframe does not carry data but carries all or part of control signaling. A non almost blank subframe in the present invention refers to a subframe having normal power on radio resources. For example, the non almost blank subframe is a subframe that can normally carry information.

In different embodiments of the present invention, different almost blank subframes may be configured for different second cells, and transmission power of each almost blank subframe may be adaptively adjusted according to the adjustment information about the second cell, so that signal transmission of the second base station on the almost blank subframe is protected, that is, the second base station may perform normal-power data transmission on the almost blank subframe, and prevent interference between the first cell and the second cell.

The embodiments are hereinafter described in detail with reference to accompanying drawings.

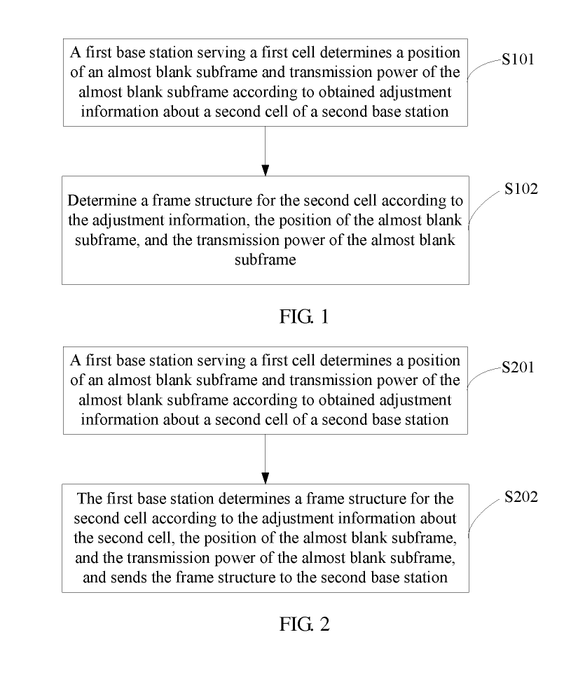

A first embodiment of the present invention provides a communication method. As shown in FIG. 1, the method includes the following:

S101. A first base station serving a first cell determines a position of an almost blank subframe and transmission power of the almost blank subframe according to obtained adjustment information about a second cell of a second base station.

S102. Determine a frame structure for the second cell according to the adjustment information, the position of the almost blank subframe, and the transmission power of the almost blank subframe.

In this embodiment, through the configuration of the almost blank subframe, the first base station does not send data on the almost blank subframe to the terminal device, while the second base station may transmit data on the almost blank subframe with normal power to the terminal device. Therefore, the terminal device does not receive channel interference from the first base station when receiving data sent by the second base station, a signal to interference plus noise ratio can satisfy requirements, and the spectrum efficiency of the first base station on the almost blank subframe is improved. Different time domain transmission resources may also be flexibly allocated according to different service requirements of the second cell.

A second embodiment of the present invention provides a communication method. As shown in FIG. 2, the method includes the following:

S201. A first base station serving a first cell determines a position of an almost blank subframe and transmission power of the almost blank subframe according to obtained adjustment information about a second cell of a second base station.

S202. The first base station determines a frame structure for the second cell according to the adjustment information about the second cell, the position of the almost blank subframe, and the transmission power of the almost blank subframe, and sends the frame structure to the second base station.

In S201, the adjustment information about the second cell may be obtained by the first base station before the first base station configures a subframe format, or obtained by the first base station beforehand, and can be obtained in multiple modes. In this embodiment, the first base station may receive the adjustment information about the second cell through an X2 interface, an S1 interface, or a Uu interface, and so on. For example, when information is received and transmitted between the first base station and the second base station through the Uu interface, the second base station may broadcast or send adjustment information to the second cell, and the first base station may read the adjustment information, or the terminal device may also read the adjustment information and report the adjustment information to the first base station.

The adjustment information about the second cell may be a current load of the second cell and maximum transmission power of the first base station tolerable to the second cell. Or the adjustment information about the second cell may be a current load and an interference threshold of the second cell. The current load of the second cell refers to the radio resource load of the second cell. The interference threshold is a threshold of radio frequency interference that is caused by the first base station and received by the second cell. In this embodiment, the interference threshold may be understood as the maximum value of the radio frequency interference that is caused by the first base station to the second cell. The interference threshold may also be understood as the maximum value of the received power that is sent by the first base station and received by the second cell. Of course, in other embodiments, the current load of the first cell is used as the weighted value of the radio frequency interference caused by the first base station to the second cell, and a specific value of the interference threshold is determined according to the weighted value and used as the interference threshold. The current load of the first cell refers to the radio resource load of the first cell.

The maximum transmission power of the first base station tolerable to the second cell may be determined according to the interference threshold of the second cell and path loss between the first cell and the second cell. For example, the first base station may determine the maximum transmission power of the first base station tolerable to the second cell according to a ratio of the interference threshold of the second cell to the path loss between the first cell and the second cell. Or the second base station determines the maximum transmission power of the first base station tolerable to the second cell according to the ratio of the interference threshold of the second cell to the path loss between the first cell and the second cell, and the second base station sends the maximum transmission power of the first base station tolerable to the second cell, to the first base station.

For example, the first base station may obtain relative physical positions of the first cell and the second cell to determine the path loss between the first cell and the second cell. Determination of the path loss may be executed by the first base station or may also be executed by the second base station.

S201 further includes: determining, by the first base station, the maximum transmission power of the first base station tolerable to the second cell; and determining, by the first base station, the transmission power of the almost blank subframe corresponding to the almost blank subframe according to the maximum transmission power of the first base station tolerable to the second cell.

The position of the almost blank subframe may be embodied by many types of information. For example, the position of the almost blank subframe may be embodied by a subframe number of the almost blank subframe, that is, the position of the almost blank subframe is determined once the subframe number of the almost blank subframe is determined. For another example, the position of the almost blank subframe may be embodied by the quantity of almost blank subframes; when the total quantity of subframes and the quantity of almost blank subframes are determined, the position of the almost blank subframe is determined according to a certain rule or pre-agreement. For another example, the position of the almost blank subframe may be embodied by position information of the first almost blank subframe in the frame structure and information about position intervals between other almost blank subframes and the first almost blank subframe in the frame structure. Of course, the position of the almost blank subframe may also be embodied by other information, so long as the position of the almost blank subframe can be determined, which will not be further described herein.

In this embodiment, the first base station may determine the quantity of almost blank subframes for the second cell according to the current load ratio of the second cell. Specifically, the first base station obtains the current load of the second cell, and determines the current load ratio of the second cell according to the following formula (1):

current load ratio of the second cell=current load of the second cell/(total current load of all second cells+load of the first cell) Formula (1)

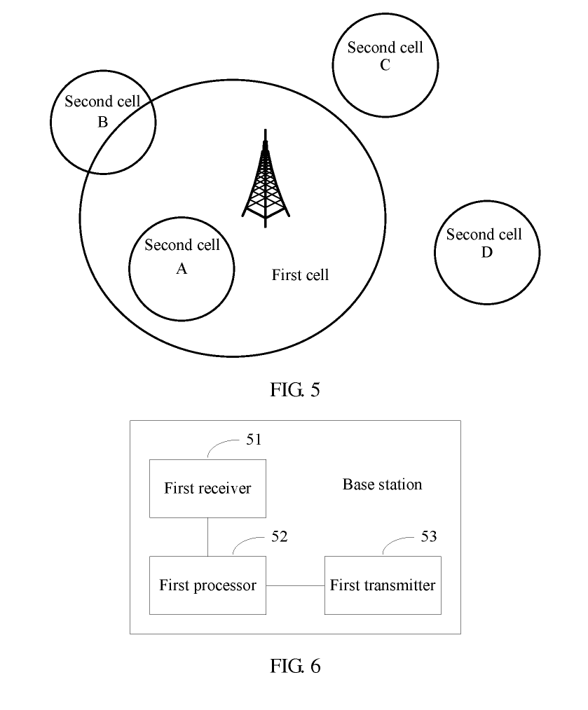

Further as shown in FIG. 5, a network scenario including one first cell and four second cells (A, B, C, and D) is used as an example for description. It is assumed that: the first cell is an interference source cell and the second cells are victim cells, and according to formula (1), the current load ratio of the current load of the second cell A to the total load of the first cell and all second cells (A, B, C, and D) is 10%, and the current load ratio of the current load of any one of the second cells B, C, and D to the total load of the first cell and all second cells (A, B, C, and D) is 20%. Therefore, it may be determined that the quantity of subframes of the almost blank subframes respectively required by the second cells (A, B, C, and D) does not exceed 2. For example, it may be determined that the quantity of subframes of the almost blank subframes required by the second cell A is 1, and that the quantity of the almost blank subframes required by any one of second cells B, C, and D is 2.

In this embodiment, the quantity of almost blank subframes may be determined according to the above method, and the position of the almost blank subframe in the frame structure may be further determined according to the quantity of the almost blank subframes. Of course, the position of the almost blank subframe may also be embodied by other information or in a predetermined mode, so long as the position of the almost blank subframe can be determined, which will not be further described herein.

In S202, specifically, the frame structure for the second cell may be determined by the first base station according to the maximum transmission power of the first base station tolerable to the second cell, the position of the almost blank subframe, and the transmission power of the almost blank subframe, or determined by the first base station according to the interference threshold of the second cell, the position of the almost blank subframe, and the transmission power of the almost blank subframe. The maximum transmission power of the first base station tolerable to the second cell may be calculated according to the interference threshold of the second cell, which is described in detail in S201 and will not be further described herein.

For example, the network scenario shown in FIG. 5 is further used as an example for description. It is assumed that the first base station has different transmission power, which is respectively P₁ and P₂, and that the maximum transmission power of the first base station tolerable to the second cells (A, B, C, and D) is P_{A}, P_{B}, P_{C}, and P_{D} respectively, where P_{B}=P_{C}=P_{D} and P₁≦P_{A}<P₂≦P_{B}.

A frame structure including 10 subframes is used as an example. It is assumed that the frame structure includes two almost blank subframes, and that the remaining subframes are non almost blank subframes. Possible positions of the almost blank subframes in the frame structure are: An almost blank subframe with transmission power being P₁ is the first subframe, and an almost blank subframe with transmission power being P₂ is the second subframe. Of course, the almost blank subframes with transmission power respectively being P₁ and P₂ may also be other subframes located in the frame structure, for example, the almost blank subframes with transmission power respectively being P₁ and P₂ may also be the third subframe and the fourth subframe located in the frame structure.

For the second cells (B, C, and D), when P_{B}=P_{C}=P_{D} and P₁≦P_{A}<P₂≦P_{B}, the second base station may determine that the transmission power of the first and second almost blank subframes satisfies the maximum transmission power P_{B}, P_{C}, and P_{D} of the first base station tolerable to the second cells (B, C, and D). Therefore, the second base station may determine the frame structure for the second cells (B, C, and D), for example, 1100000000, or 0011111111. That is, for the first base station, the first subframe and the second subframe are almost blank subframes, and for the second base station, normal-power transmission and data transmission may be performed on the first subframe and/or the second subframe, thereby avoiding interference between the first cell and the second cells (B, C, and D).

For the second cell A, when P_{B}=P_{C}=P_{D} and P₁≦P_{A}≦P₂≦P_{B}, the second base station may determine that the transmission power of the first almost blank subframe satisfies the maximum transmission power P_{A} of the first base station tolerable to the second cell A. Therefore, the second base station may determine the frame structure for the second cell A, for example, 1000000000, or 0111111111. That is, for the first base station, the first subframe is an almost blank subframe, and for the second base station, normal-power transmission and data transmission may be performed on the first subframe, thereby avoiding interference between the first cell and the second cell A.

Further, the first base station sends the frame structure to the second base station serving the second cells (A, B, C, and D).

In this embodiment, the first base station sends, through an X2 interface, the frame structure to the second base station serving the second cell. Or the first base station sends, through an S1 interface or a Uu interface (the Uu interface is, for example, an air interface), the frame structure to the second base station serving the second cell. For example, when information is received and transmitted between the first and second base stations through the Uu interface, the first base station sends the frame structure in the broadcast of the first cell controlled by the first base station, and the second base station reads the broadcast to obtain the frame structure. For another example, after the terminal device reads the broadcast in the first cell, the terminal device reports the frame structure to the second base station.

With the solution provided by this embodiment, the first base station may determine the frame structure for the second cell and send the frame structure to the second base station, so that the interference between the first cell and the second cell is reduced. Meanwhile, the second base station may perform data transmission according to the almost blank subframe of the frame structure determined by the first base station for the second cell, so that the spectrum efficiency of the first cell on the almost blank subframe is improved. Because the configuration of the almost blank subframe fully considers the related information of the second cell, different time domain transmission resources may be flexibly allocated according to different service requirements of the second cell.

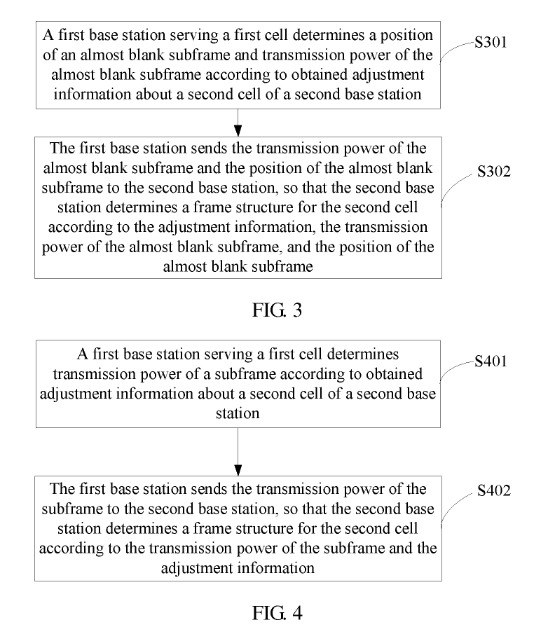

A third embodiment of the present invention provides a communication method. As shown in FIG. 3, the method includes the following:

S301. A first base station serving a first cell determines a position of an almost blank subframe and transmission power of the almost blank subframe according to obtained adjustment information about a second cell of a second base station.

S302. The first base station sends the transmission power of the almost blank subframe and the position of the almost blank subframe to the second base station, so that the second base station determines a frame structure for the second cell according to the adjustment information, the transmission power of the almost blank subframe, and the position of the almost blank subframe.

S301 is approximately the same as S201 in the second embodiment, and will not be further described herein.

In S302, the first base station notifies the second base station of the transmission power and the corresponding position of the almost blank subframe, and the second base station determines an available frame structure by itself according to the maximum transmission power of the first base station tolerable to the second cell and the interference threshold of the second cell.

Specifically, the second base station determines the frame structure for the second cell according to the maximum transmission power of the first base station tolerable to the second cell, the position of the almost blank subframe, and the transmission power of the almost blank subframe, or the second base station determines the frame structure for the second cell according to the interference threshold of the second cell, the position of the almost blank subframe, and the transmission power of the almost blank subframe.

The maximum transmission power of the first base station tolerable to the second cell may be calculated according to the interference threshold of the second cell, and for details, reference may be made to the related description in the second embodiment, which will not be further described herein.

For example, further as shown in FIG. 5, a network scenario including the first cell and the second cells (A, B, C, and D) is used as an example for description. A frame structure including 10 subframes is used as an example. It is assumed that the frame structure includes two almost blank subframes, and that the remaining subframes are non almost blank subframes. Possible positions of the almost blank subframes in the frame structure are: An almost blank subframe with transmission power being P₁ is the first subframe, and an almost blank subframe with transmission power being P₂ is the second subframe. It is assumed that the transmission power of the almost blank subframes corresponding to the first and second subframes in the frame structure is P₁=30 dBm and P₂=39 dBm respectively, and that the maximum transmission power of the first base station tolerable to the second cells (A, B, C, and D) is P_{A}, P_{B}, P_{C}, and P_{D} respectively, where P_{B}=P_{C}=P_{D} and P₁≦P_{A}<P₂≦P_{B}. In this scenario, the first base station may send only the positions of the almost blank subframes and transmission power information corresponding to the almost blank subframes to the second base station, without sending transmission power information corresponding to non almost blank subframes, for example, the transmission power information may be sent to the second base station in the form shown in Table 1. Of course, persons skilled in that art may know that the first base station may also send the power information corresponding to non almost blank subframes to the second base station, or send the positions of the almost blank subframes and the transmission power information corresponding to the almost blank subframes to the second base station in other forms, so long as the second base station can determine the positions of the almost blank subframes and the transmission power corresponding to the almost blank subframes.

TABLE 1

| | Subframe Index | | | | | | | | | |
|---|---|---|---|---|---|---|---|---|---|---|
| | 1 | 2 | 3 | 4 | 5 | 6 | 7 | 8 | 9 | 10 |
| Power Level | 30 dBm | 39 dBm | / | / | / | / | / | / | / | / |

When the second base station serving the second cells (A, B, C, and D) receives the information shown in Table 1, the second base station first determines that the first and second subframes are almost blank subframes and determines the corresponding transmission power.

According to P_{B}=P_{C}=P_{D} and P₁≦P_{A}<P₂≦P_{B}, the second base station may determine that the transmission power of the first and second almost blank subframes satisfies the maximum transmission power of the first base station tolerable to the second cells (B, C, and D). Therefore, the second base station may determine the frame structure for the second cells (B, C, and D), for example, 1100000000, or 0011111111. That is, for the first base station, the first and second subframes are almost blank subframes, and for the second base station, normal-power transmission and data transmission may be performed on the first subframe and/or the second subframe, thereby avoiding interference between the first cell and the second cell E. Of course, the almost blank subframes with transmission power respectively being P₁ and P₂ may also be other subframes located in the frame structure, for example, the almost blank subframes with transmission power respectively being P₁ and P₂ may also be the third subframe and the fourth subframe located in the frame structure, which will not be further described herein.

Likewise, according to P_{B}=P_{C}=P_{D} and P₁≦P_{A}<P₂≦P_{B}, the second base station may determine that the transmission power of the first almost blank subframe satisfies the maximum transmission power of the first base station tolerable to the second cell A. Therefore, the second base station may determine the frame structure for the second cell A, for example, 1000000000, or 0111111111. That is, for the first base station, the first subframe is an almost blank subframe, and for the second base station, normal-power transmission and data transmission may be performed on the first subframe, thereby avoiding interference between the first cell and the second cell A.

For another example, as shown in Table 2, a network scenario including one first cell and four second cells (E, F, G, and H) is used as an example for description.

It is assumed that the maximum transmission power of the first base station tolerable to the second cells (E, F, G, and H) is Pₑ, P_{f}, P_{g}, and Pₕ respectively.

According to the above formula (1), the first base station calculates the current load ratio of each of the second cells (E, F, G, and H). Assuming that the current load ratio of the second cell G is the greatest in the second cells (E, F, G, and H), the quantity of almost blank subframes required by any one of the second cells (E, F, G, and H) is determined according to a predefined mode or a mode described in the second embodiment. According to the determined quantity of almost blank subframes, the position of the almost blank subframe in the frame structure may be further determined Of course, the position of the almost blank subframe may also be determined according to the predefined mode or the mode described in the second embodiment, which will not be further described herein.

Further, the first base station determines the transmission power of the almost blank subframe according to the maximum transmission power of the first base station tolerable to the second cells (E, F, G, and H), and sends the position of the almost blank subframe and the transmission power information of the almost blank subframes to the second base station. The second base station receives the position of the almost blank subframe and the transmission power information of the almost blank subframes, and determines the frame structure for each of the second cells (E, F, G, and H) according to the maximum transmission power of the first base station tolerable to the second cells (E, F, G, and H) respectively.

It is assumed that the first base station determines that the second, fourth, sixth, and eighth subframes are almost blank subframes, and that the corresponding transmission power is P₂, P₄, P₆, and P₈ respectively. The first base station may send the positions and the transmission power corresponding to the almost blank subframes to the second base station in the form shown in Table 2. Of course, the positions and the transmission power of the almost blank subframes may also be sent in other forms, which will not be further described herein.

TABLE 2

| | Subframe Index | | | | | | | | | |
|---|---|---|---|---|---|---|---|---|---|---|
| | 1 | 2 | 3 | 4 | 5 | 6 | 7 | 8 | 9 | 10 |
| Power Level | / | P₂ | / | P₄ | / | P₆ | / | P₈ | / | / |

The maximum transmission power of the first base station tolerable to the second cell E is Pₑ. If P₂≦Pₑ, P₄>Pₑ, P₆>Pₑ, and P₈≦Pₑ, the second base station may determine that the transmission power of the second and eighth almost blank subframes satisfies the maximum transmission power of the first base station tolerable to the second cell E. Therefore, the second base station may determine the frame structure for the second cell E, for example, 0100000100, or 1011111011. That is, for the first base station, the second and eighth subframes are almost blank subframes, and for the second base station, normal-power transmission and data transmission may be performed on the second subframe and/or the eighth subframe, thereby avoiding interference between the first cell and the second cell E.

The maximum transmission power of the first base station tolerable to the second cell F is P_{f}. If P₂≦P_{f}, P₄≦P_{f}, P₆>P_{f}, and P₈≦P_{f}, the second base station may determine that the transmission power of the second, fourth, and eighth almost blank subframes satisfies the maximum transmission power of the first base station tolerable to the second cell F. Therefore, the second base station may determine the frame structure for the second cell F, for example, 0101000100, or 1010111011. That is, for the first base station, the second, fourth, and eighth subframes are almost blank subframes, and for the second base station, normal-power transmission and data transmission may be performed on different combinations of the second subframe, and/or the fourth subframe, and/or the eighth subframe, thereby avoiding interference between the first cell and the second cell F. For example, the second base station may perform normal-power transmission and data transmission on the second subframe, or on the second and fourth subframes, or on the second, fourth, and eighth subframes, which will not be further described herein.

The maximum transmission power of the first base station tolerable to the second cell G is P_{g}. If P₂≦P_{g}, P₄≦P_{g}, P₆≦P_{g}, and P₈≦P_{g}, the second base station may determine that all transmission power of the second, fourth, sixth, and eighth almost blank subframes satisfies the maximum transmission power of the first base station tolerable to the second cell G. Therefore, the second base station may determine the frame structure for the second cell G, for example, 0101010100, or 1010101011. That is, for the first base station, the second, fourth, sixth, and eighth subframes are almost blank subframes. For the second base station, normal-power transmission and data transmission may be performed on different combinations of the second subframe, and/or the fourth subframe, and/or the sixth subframe, and/or the eighth subframe, thereby avoiding interference between the first cell and the second cell G, which will not be further described herein.

The maximum transmission power of the first base station tolerable to the second cell H is Pₕ. If P₂≦Pₕ, P₄>Pₕ, P₆>Pₕ, and P₈>Pₕ, the second base station may determine that the transmission power of the second almost blank subframe satisfies the maximum transmission power of the first base station tolerable to the second cell H. Therefore, the second base station may determine the frame structure for the second cell H, for example, 0100000000, or 1011111111. That is, for the first base station, the second subframe is an almost blank subframe. For the second base station, normal-power transmission and data transmission may be performed on the second subframe, thereby avoiding interference between the first cell and the second cell H.

In this embodiment, the first base station sends, through an X2 interface, the subframe positions and transmission power of the almost blank subframes to the second base station serving the second cell. Or the first base station sends, through an S1 interface or a Uu interface (the Uu interface is, for example, an air interface), the subframe positions and transmission power of the almost blank subframes to the second base station serving the second cell. For example, when information is received and transmitted between the first and second base stations through the Uu interface, the first base station sends the subframe positions and transmission power of the almost blank subframes in the broadcast of the first cell controlled by the first base station, and the second base station reads the broadcast to obtain the subframe positions and transmission power of the almost blank subframes. For another example, after reading the broadcast in the first cell, the terminal device reports the subframe positions and transmission power of the almost blank subframes to the second base station.

Therefore, in the third embodiment, the second base station receives the positions and transmission power of the almost blank subframes, which are sent by the first base station, and determines a frame structure for the second cell by itself according to the maximum transmission power of the first base station tolerable to the second cell, so that interference between the first cell and the second cell is reduced, and the spectrum efficiency of the first cell on the almost blank subframes is improved. Different time domain transmission resources may also be flexibly allocated according to different service requirements of the second cell.

A fourth embodiment of the present invention provides a communication method. As shown in FIG. 4, the method includes the following:

S401. A first base station serving a first cell determines transmission power of a subframe according to obtained adjustment information about a second cell of a second base station.

S402. The first base station sends the transmission power of the subframe to the second base station, so that the second base station determines a frame structure for the second cell according to the transmission power of the subframe and the adjustment information.

In S401, the subframe transmission power determined by the first base station includes transmission power of an almost blank subframe in the determined frame structure, and transmission power of a non almost blank subframe. The step of determining a position of an almost blank subframe and transmission power of the almost blank subframe by the first base station according to adjustment information about the second cell is the same as S201 in the second embodiment and S301 in the third embodiment. In addition, the first base station may obtain the transmission power of the non almost blank subframe by itself according to the current load of the first cell, which will not be further described herein.

In S402, the second base station determines a frame structure for the second cell according to the transmission power of the subframe and the maximum transmission power of the first base station tolerable to the second cell, or according to the transmission power of the subframe and the interference threshold of the second cell.

The maximum transmission power of the first base station tolerable to the second cell may be calculated according to the interference threshold of the second cell, and for details, reference may be made to the related description in the second embodiment, which will not be further described herein.

For example, the first base station may send all subframes and their power information to the second base station. For example, the transmission power of the subframes is sent to the second base station in the form shown in Table 3, or may also be sent to the second base station in other forms.

TABLE 3

| | Subframe Index | | | | | | | | | |
|---|---|---|---|---|---|---|---|---|---|---|
| | 1 | 2 | 3 | 4 | 5 | 6 | 7 | 8 | 9 | 10 |
| Power | 46 dBm | 30 dBm | 46 dBm | 46 dBm | 46 dBm | 46 dBm | 46 dBm | 39 dBm | 46 dBm | 46 dBm |
| Level | | | | | | | | | | |

Still using the network scenario shown in FIG. 5 as an example for description, after the second base station receives the information shown in Table 3, the second base station determines, according to the transmission power of each subframe, that the second and eighth subframes are almost blank subframes, and determines the corresponding transmission power of the almost blank subframes. For the mode of determining, by the second base station, the frame structure for the second cell according to the positions of the almost blank subframes and corresponding transmission power, and the maximum transmission power of the first base station tolerable to the second cell, or according to the positions of the almost blank subframes and the corresponding transmission power, and the interference threshold of the second cell, reference may be made to the related description in the third embodiment, which will not be further described herein.

In this embodiment, the first base station sends, through an X2 interface, the transmission power of the subframes to the second base station serving the second cell. Or the first base station sends, through an S1 interface or a Uu interface (the Uu interface is, for example, an air interface), the transmission power of the subframes to the second base station serving the second cell. For example, when information is received and transmitted between the first and second base stations through the Uu interface, the first base station sends the transmission power of the subframes in the broadcast of the first cell controlled by the first base station, and the second base station reads the broadcast to obtain the transmission power of the subframes. For another example, after the terminal device reads the broadcast in the first cell, the terminal device reports the transmission power of the subframes to the second base station.

With the solution provided by this embodiment, the second base station may determine the frame structure by itself according to the subframe transmission power received from the first base station and the maximum transmission power of the first base station tolerable to the second cell, so that interference between the first cell and the second cell is reduced, and the spectrum efficiency of the first cell on the almost blank subframes is improved. Different time domain transmission resources may also be flexibly allocated according to different service requirements of the second cell.

A fifth embodiment of the present invention provides a base station. As shown in FIG. 6, the main structure of the base station includes:

a first receiver 51, configured to receive adjustment information about a second cell of a second base station; a first processor 52, configured to determine a position of an almost blank subframe and transmission power of the almost blank subframe according to the adjustment information about the second cell, and determine a frame structure for the second cell according to the adjustment information, the position of the almost blank subframe, and the transmission power of the almost blank subframe; and a first transmitter 53, configured to send the frame structure to the second base station.

The first processor 52 is further configured to determine maximum transmission power of the base station tolerable to the second cell according to an interference threshold of the second cell and path loss between a first cell of the base station and the second cell.

The first processor 52 is further configured to determine the transmission power of the almost blank subframe according to the maximum transmission power of the base station tolerable to the second cell.

The base station may implement the actions executed by the first base station in the method for configuring almost blank subframes in the first to fourth embodiments, for example, the first processor 52 may execute the action of S102 in the first embodiment, and may also execute the action of S202 in the second embodiment, so that interference between the first cell and the second cell is reduced, and the spectrum efficiency of the first cell on the almost blank subframe is improved. Different time domain transmission resources may also be flexibly allocated according to different service requirements of the second cell.

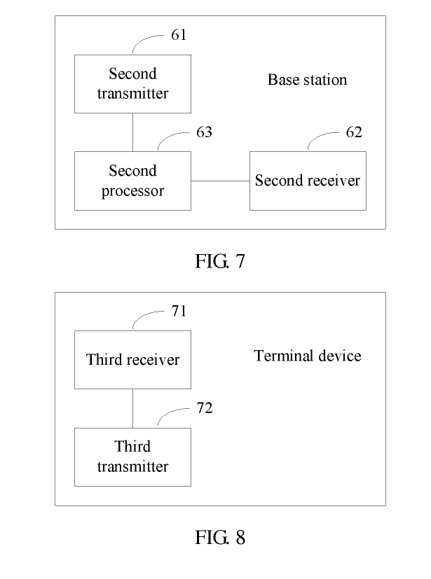

A sixth embodiment of the present invention provides a base station. As shown in FIG. 7, the main structure of the base station includes:

a second transmitter 61, configured to transmit adjustment information about a second cell of the base station to a first base station serving a first cell; a second receiver 62, configured to receive a position of an almost blank subframe and transmission power of the almost blank subframe, which are determined by the first base station according to the adjustment information; and a second processor 63, configured to determine a frame structure for the second cell according to the adjustment information, the position of the almost blank subframe, and the transmission power of the almost blank subframe.

The second processor 63 is further configured to determine maximum transmission power of the first base station tolerable to the second cell according to an interference threshold of the second cell and path loss between the first cell and the second cell.

The base station may implement the actions executed by the second base station in the method for configuring an almost blank subframe in the first to fourth embodiments, for example, the second processor 63 may execute the action of S102 in the first embodiment, and may also execute the action of S302 in the third embodiment, so that interference between the first cell and the second cell is reduced, and the spectrum efficiency of the first cell on the almost blank subframe is improved. Different time domain transmission resources may also be flexibly allocated according to different service requirements of the second cell.

Persons skilled in the art may understand that the first cell (such as an interference source cell) and the second cell (such as a victim cell) in this embodiment are relative, and that the second cell may be a victim cell relative to the first cell and may also be an interference source cell relative to other cells. The base station in this embodiment may serve as a base station of the victim cell, or may also serve as a base station of the interference source cell and include the function of the base station in the fifth embodiment.

A seventh embodiment of the present invention provides a terminal device. As shown in FIG. 8, the main structure of the terminal device includes: a third receiver 71, configured to receive a frame structure for a second cell of a second base station, which is sent in a first cell by a first base station, where the frame structure is determined by the first base station according to adjustment information about the second cell, a subframe position of an almost blank subframe, and transmission power of the almost blank subframe; and a third transmitter 72, configured to send the frame structure to the second base station.

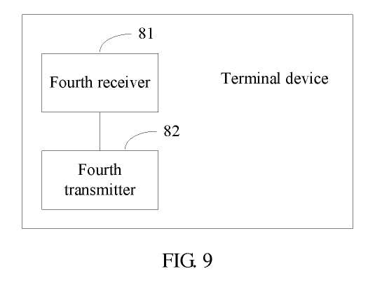

An eighth embodiment of the present invention provides a terminal device. As shown in FIG. 9, the main structure of the terminal device includes: a fourth receiver 81, configured to receive a subframe position of an almost blank subframe and transmission power of the almost blank subframe, which are sent in a first cell by a first base station and determined according to adjustment information about a second cell of a second base station; and a fourth transmitter 82, configured to send the subframe position of the almost blank subframe and the transmission power of the almost blank subframe to the second base station, so that the second base station determines a frame structure for the second cell according to the adjustment information about the second cell, the subframe position of the almost blank subframe, and the transmission power of the almost blank subframe.

The first base station in the seventh and eighth embodiments of the present invention may implement the actions executed by the first base station in the method for configuring an almost blank subframe in the first to fourth embodiments, for example, the first base station may execute the action of S102 in the first embodiment and may also execute the action of S202 in the second embodiment. The second base station in the seventh and eighth embodiments of the present invention may implement the actions executed by the second base station in the method for configuring an almost blank subframe in the first to fourth embodiments, for example, the second base station may execute the action of S102 in the first embodiment and may also execute the action of S302 in the third embodiment. Therefore, the terminal device in the seventh and eighth embodiments can normally receive messages sent by the second base station, and interference caused by the first base station to the terminal device is reduced.

The present invention further provides a communication system, including the first base station, the second base station, and the terminal device in the foregoing embodiments. In the communication system, through the configuration of the almost blank subframe, interference is avoided in data transmission between the first base station and the second base station, and the terminal device can normally receive messages sent by the first base station and the second base station, so that the spectrum efficiency of the first cell on the almost blank subframe is improved. Different time domain transmission resources may also be flexibly allocated according to different service requirements of the second cell.

The foregoing embodiments are merely used for describing the technical solutions of the present invention, but not intended to limit the present invention. Although the present invention is described in detail with reference to the foregoing embodiments, persons of ordinary skill in the art should understand that they can still make modifications to the technical solutions described in the embodiments or make equivalent replacements to some technical features thereof, as long as such modifications or replacements do not cause the essence of corresponding technical solutions to depart from the scope of the technical solutions provided by the embodiments of the present invention.

What is claimed is:

1. A communication method, comprising:
determining, by a first base station serving a first cell, a position of an almost blank subframe and transmission power of the almost blank subframe according to obtained adjustment information about a second cell of a second base station; and
determining a frame structure for the second cell according to the adjustment information, the position of the almost blank subframe, and the transmission power of the almost blank subframe.

2. The communication method according to claim 1, wherein the determining a frame structure for the second cell according to the adjustment information, the position of the almost blank subframe, and the transmission power of the almost blank subframe comprises:
determining, by the first base station, the frame structure for the second cell according to the adjustment information, the position of the almost blank subframe, and the transmission power of the almost blank subframe, and sending the frame structure to the second base station.

3. The communication method according to claim 1, wherein the determining a frame structure for the second cell according to the adjustment information, the position of the almost blank subframe, and the transmission power of the almost blank subframe comprises:
sending, by the first base station, the transmission power of the almost blank subframe and the position of the almost blank subframe to the second base station, so that the second base station determines the frame structure for the second cell according to the adjustment information, the position of the almost blank subframe, and the transmission power of the almost blank subframe.

4. The communication method according to claim 1, further comprising:
obtaining, by the first base station, the adjustment information, wherein
the adjustment information comprises a current load of the second cell and maximum transmission power of the first base station tolerable to the second cell, or the adjustment information comprises a current load and an interference threshold of the second cell.

5. The communication method according to claim 4, wherein the obtaining, by the first base station, the adjustment information comprises:
determining, by the first base station, the maximum transmission power of the first base station tolerable to the second cell according to the interference threshold of the second cell and path loss between the first cell and the second cell; or
receiving, by the first base station, the maximum transmission power of the first base station tolerable to the second cell from the second base station, wherein the maximum transmission power of the first base station tolerable to the second cell is determined by the second base station according to the interference threshold of the second cell and path loss between the first cell and the second cell.

6. The communication method according to claim 4, further comprising:
determining, by the first base station, the transmission power of the almost blank subframe according to the maximum transmission power of the first base station tolerable to the second cell.

7. The communication method according to claim 4, wherein the determining a frame structure for the second cell according to the adjustment information, the position of the almost blank subframe, and the transmission power of the almost blank subframe comprises:
determining the frame structure for the second cell according to the maximum transmission power of the first base station tolerable to the second cell, the position of the almost blank subframe, and the transmission power of the almost blank subframe; or
determining the frame structure for the second cell according to the interference threshold of the second cell, the position of the almost blank subframe, and the transmission power of the almost blank subframe.

8. The communication method according to claim 1, wherein the first cell is an interference source cell, and the second cell is a victim cell.

9. The communication method according to claim 1, wherein the first cell and the second cell are neighboring cells.

10. A base station, comprising:
a first receiver, configured to receive adjustment information about a second cell of a second base station;
a first processor, configured to determine a position of an almost blank subframe and transmission power of the almost blank subframe according to the adjustment information, and determine a frame structure for the second cell according to the adjustment information, the position of the almost blank subframe, and the transmission power of the almost blank subframe; and
a first transmitter, configured to send the frame structure to the second base station.

11. The base station according to claim 10, wherein:
the adjustment information comprises a current load of the second cell and maximum transmission power of the base station tolerable to the second cell; or
the adjustment information comprises a current load and an interference threshold of the second cell.

12. The base station according to claim 10, wherein:
the first processor is further configured to determine the maximum transmission power of the base station tolerable to the second cell according to the interference threshold of the second cell and path loss between a first cell of the base station and the second cell.

13. The base station according to claim 10, wherein:
the first processor is further configured to determine the transmission power of the almost blank subframe according to the maximum transmission power of the base station tolerable to the second cell.

14. A base station, comprising:
a second transmitter, configured to transmit adjustment information about a second cell of the base station to a first base station serving a first cell;
a second receiver, configured to receive a position of an almost blank subframe and transmission power of the almost blank subframe, which are determined by the first base station according to the adjustment information; and
a second processor, configured to determine a frame structure for the second cell according to the adjustment information, the position of the almost blank subframe, and the transmission power of the almost blank subframe.

15. The base station according to claim 14, wherein:
the adjustment information comprises a current load of the second cell and maximum transmission power of the first base station tolerable to the second cell; or
the adjustment information comprises a current load and an interference threshold of the second cell.

16. The base station according to claim 14, wherein:
the second processor is further configured to determine the maximum transmission power of the first base station tolerable to the second cell according to the interference threshold of the second cell and path loss between the first cell and the second cell.

17. A terminal device, comprising:
a third receiver, configured to receive a frame structure for a second cell of a second base station, which is sent in a first cell by a first base station, wherein the frame structure is determined by the first base station according to adjustment information about the second cell, a subframe position of an almost blank subframe, and transmission power of the almost blank subframe; and
a third transmitter, configured to send the frame structure to the second base station.

18. The terminal device according to claim 17, wherein:
the transmission power of the almost blank subframe is determined by the first base station according to maximum transmission power of the first base station tolerable to the second cell.

19. A terminal device, comprising:
a fourth receiver, configured to receive a subframe position of an almost blank subframe and transmission power of the almost blank subframe, which are sent in a first cell by a first base station and determined according to adjustment information about a second cell of a second base station; and
a fourth transmitter, configured to send the subframe position of the almost blank subframe and the transmission power of the almost blank subframe to the second base station, so that the second base station determines a frame structure for the second cell according to the adjustment information about the second cell, the subframe position of the almost blank subframe, and the transmission power of the almost blank subframe.

20. The terminal device according to claim 19, wherein:
the transmission power of the almost blank subframe is determined by the first base station according to maximum transmission power of the first base station tolerable to the second cell.
